(19) United States
(12) Patent Application Publication
(10) Pub. No.: US 2009/0188987 A1
(43) Pub. Date: Jul. 30, 2009

(54) MULTI-CHAMBERED COATING CARTRIDGE

(75) Inventors: Bruce A. Connelly, Gibsonia, PA (US); John R. Rassau, Allison Park, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/022,182

(22) Filed: Jan. 30, 2008

(51) Int. Cl. B05B 7/24; B05B 7/04

(52) U.S. Cl. 239/8; 206/568; 222/153.06; 239/309; 239/1

(57) ABSTRACT

A multiple chambered coating cartridge is disclosed. The coating cartridge may have a container with a first chamber and a second chamber, a removable barrier between the first and second chambers, a first component in the first chamber and a second component in the second chamber wherein at least one of the first component and second component has a low viscosity. Also disclosed are a method of filling a coating cartridge and a method of spray painting utilizing a multiple chambered coating cartridge. In addition, an apparatus for spray painting comprising a spray gun and a cartridge with a removable barrier is disclosed.

### FIELD OF THE INVENTION

The present invention relates to containers for use with paint spray guns.

### BACKGROUND INFORMATION

Spray guns for painting, commonly used for vehicle refinishing, are often fed from a metal or plastic cup that attaches directly to a spray gun. Many of these gun and cup combinations allow gravity feeding of the coating inside the cup into the gun. However, before the cup can be installed on the gun the coating first needs to be mixed. Many coatings used in spray gun applications are two-part coating compositions including a resin component and a hardener. These two components form the binder for the coating and, in catalyst based two-part compositions, must be stored separately. Other components of the coating, such as tint and/or solvent, may be included in the resin and/or hardener. In vehicle refinish and other applications, the operator often prepares the appropriate mix for the coating before each use. The mix is then transferred to the cup. Preparing and mixing the coating requires significant amounts of time, increases the opportunity for contamination of the composition, increases the opportunity for spills, and introduces opportunity for error while mixing. Moreover, additional handling increases operator exposure to the sometimes hazardous components of the coating.

The present invention has been developed in view of the foregoing.

### SUMMARY OF THE INVENTION

In certain respects, the present invention provides a kit for a coating comprising a container with a first chamber and a second chamber, a removable barrier between the first and second chambers, a first component in the first chamber and a second component in the second chamber wherein at least one of the first component and second component is a low viscosity liquid.

In other respects, the present invention provides a method of filling a coating cartridge comprising the steps of providing a container comprising first and second chambers separated by a removable barrier; filling the first chamber with a first coating component; and filling the second chamber with a second component

In other respects, the present invention provides an assembly for spray painting comprising a spray gun and a cartridge in fluid communication with the spray gun, wherein the cartridge comprises: a first chamber for a first paint component; a second chamber for a second paint component; and a removable barrier between the first and second chambers which is removed to allow the first and second paint components to mix.

In other respects, the present invention provides a method of spray painting comprising providing a two part cartridge containing pre-mixed coating components, mixing the coating components in the cartridge and mounting the cartridge on a spray gun.

### BRIEF DESCRIPTION OF THE DRAWINGS

FIG. 1 is a side view of a spray gun including a coating cartridge according to one embodiment of the present invention.

FIG. 2 is a side view of a coating cartridge with a sealing band according to one embodiment of the present invention.

FIG. 3 a side view of the coating cartridge of FIG. 2 with the sealing band partially removed according to one embodiment of the present invention.

FIG. 4 is a side sectional view taken through section 4-4 of FIG. 2 illustrating the coating cartridge with a sealing band and removable barrier in place.

FIG. 5A is a side sectional view of the cartridge of FIG. 3 through section 4-4 after the barrier has been removed by depressing the dasher according to one embodiment of the present invention.

FIG. 5B is a side cross-sectional view of the cartridge of FIG. 3 wherein the removable barrier has been displaced.

FIG. 6 is a side sectional view of a coating cartridge having a compression fitting for holding the removable barrier and a quick disconnect fitting for attaching to a spray gun according to one embodiment of the present invention.

FIG. 7 is a side sectional view of a coating cartridge having a removable barrier sealed between two threaded sections of the container.

FIG. 8 is a side sectional view of a coating cartridge having a dasher for breaking the removable barrier mounted in the lid according to one embodiment of the present invention.

FIG. 9 is a side sectional view of a coating cartridge having two removable barriers and three chambers according to one embodiment of the present invention.

FIG. 10 is a side sectional view of a coating cartridge having a longitudinally oriented removable barrier and two chambers according to one embodiment of the present invention.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As used herein, the term “paint” and/or “coating” refers to multiple part coating compositions having individual low viscosity component comprising at least a first component and a second component. The term “low viscosity” with regards to a component of the coating composition before mixing refers to a liquid having kinetic viscosity less than 40 seconds from a #2 Zahn cup at 20° C. The term “low viscosity” may also refer to the kinetic viscosity of the coating composition after mixing, as used in this context “low viscosity” refers to a liquid compositions with a kinetic viscosity sufficiently low enough to enable the composition to gravity feed from a cartridge into a paint spray gun. As used herein the term “cartridge” refers to a module designed to be combined with a larger piece of equipment, e.g. a pneumatic spray gun.

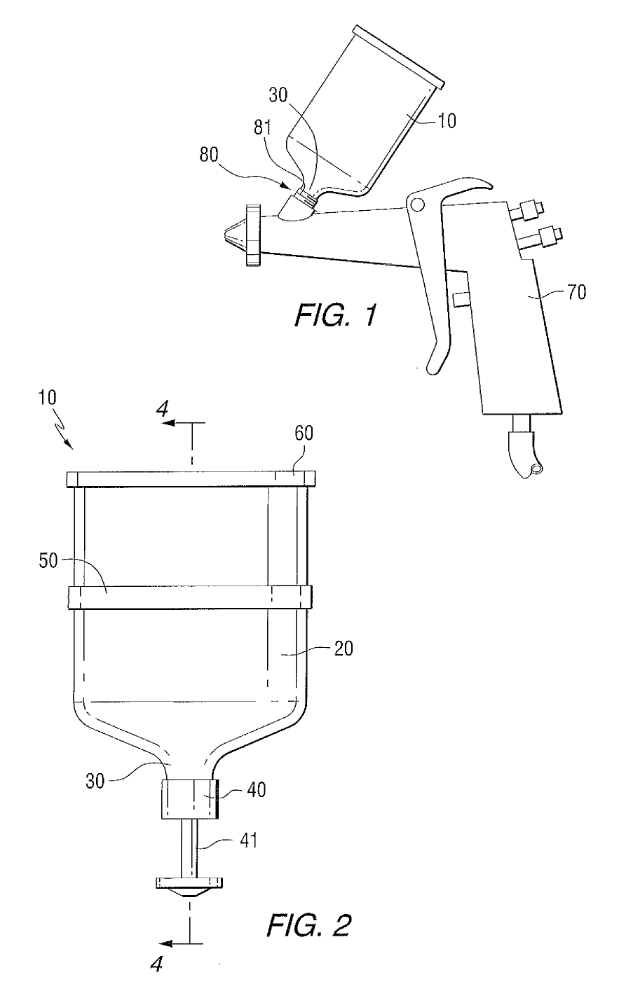

Referring now to FIG. 1, a coating cartridge 10 is shown according to one embodiment of the present invention. In this embodiment the coating has already been mixed. As shown, the coating cartridge 10 may be installed directly onto a spray gun 70 by way of a connection 80. Connection 80 may be a threaded coupling with male threads 81 on the exterior of a dispensing nozzle 30 of the cartridge 10 and female threads for receiving the cartridge 10 on the spray gun 70. The connection 80 may be made by any suitable means, for example a quick disconnect, a female thread on the cartridge 10 or any other liquid tight coupling. In addition, an adaptor may be used between the spray gun 70 and the coating cartridge 10 (not shown). For example, a reducing nipple may be used to transition from one thread size on the coating cartridge 10 to another thread size on the spray gun 70 or the adaptor may be used to make a male to female or female to male transition.

Another embodiment of the cartridge 10 for holding multiple component paint is shown in FIG. 2. The cartridge 10 has a container 20, which makes up the main body of the cartridge. The container 20 may commonly be referred to as a “cup”. Examples of suitable materials for the container include, but are not limited to, plastics, such as polyethylene, polypropylene, polystyrene, poly(ethylene terephthalate), poly(vinyl chloride), or metals, such as, steel, aluminum or alloys of such. The container 20 has a dispensing end 30 sealed by a cap 40. The dispensing end 30 is the portion of the cartridge 10 that attaches to a spray gun. The cap 40 may be fitted with a dasher 41. The dasher 41 may be slidably related to the cap 40. A liquid seal (not shown) is also arranged between the dasher 41 and the cap 40. A lid 60 seals the other end of the container 20. While a lid 60 is shown in most embodiments, the container 20 may simply be structured to have a closed end where the lid 60 is shown. However, the lid 60 will often allow for easier assembly of the cartridge 10. Whether fitted with a lid 60 or having a closed end, the end of the cartridge opposite the dispensing end has a vent (not shown) to allow the coating to flow from the container to the spray gun 70. The vent may be structured to be opened and closed or may be part of a second lid which is installed after the cartridge is mounted on a spray gun. The cartridge 10 may have a longitudinal axis depicted in FIG. 4 as L_{A}. Axially aligned with an interior barrier and wrapped around a circumference of the exterior of the container is a sealing band 50. Within the cartridge 10 of FIG. 1 are coating components separated in individual chambers.

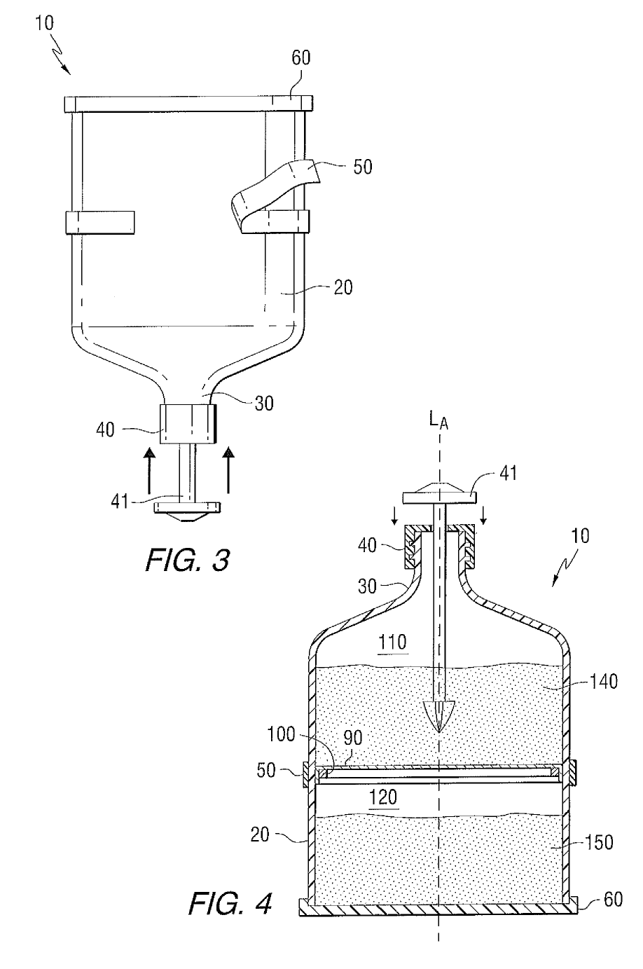

Referring now to FIG. 3, to mix the coating components prior to use the sealing band 50 is removed. The sealing band may be a tape or elastic material for example, natural or synthetic rubber. As will later be described in more detail removing the sealing band 50 frees the barrier within the container 20. The dasher 41 may then be depressed as indicated by the arrows in FIG. 3. As used herein the term “removable barrier” refers to an element capable of separating two cavities within a container and capable of being repositioned or torn so that the element no longer separates the cavities within the container. As used herein the terms “removable” and “unsealable” refer to the barrier's ability to transition from a state of dividing two chambers within a container to a state of allowing fluid communication between the chambers. For example, this may be accomplished by piercing, tearing, repositioning or removing the removable barrier. During storage of the coating cartridge the sealing band 50 may provide compression around the container 20 so that the removable barrier inside the container 20 is held in place. When the sealing band 50 is removed the removable barrier is no longer held in place.

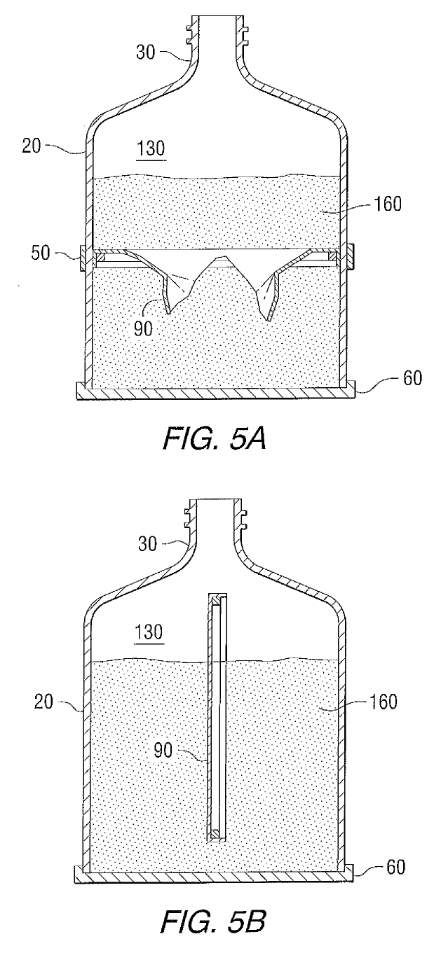

With reference now to FIGS. 4, 5A and 5B cross section of the cartridge 10 having central longitudinal axis L_{A} is shown. According to one embodiment of the present invention, a removable barrier 90 can be seen in the interior of the container 20. The removable barrier 90 may be made of a foil or other thin sheet material for example, metal or plastic. As shown in FIG. 4 the removable barrier 90 may overlap a rigid member 100. The rigid member 100 has a ring-like geometry, having a diameter slightly less than that of the interior of the container 20. The rigid member may be made from materials similar to those describe above for the container 20. The removable barrier 90 may be folded over or adhered to the rigid member 100. As can be seen in FIG. 4, with the sealing band 50 in place the removable barrier 90 is held fixably in place by the wall of the container 20 which is compressed by the sealing band 50. A first chamber 110 may be defined by the removable barrier 90, the container 20, including the dispensing nozzle 30, and the cap 40. A second chamber 120 may be defined by the container 20, the removable barrier 90, and the lid 60. As illustrated in FIG. 5A, when the sealing band 50 is removed the removable barrier 90 and rigid member 100 are no longer held in place by the wall of the container 20 and the removable barrier 90 is unsealed so that when a dasher is pushed against one side of the removable barrier 90, the removable barrier 90 flips to a vertical position and a single cavity 130 is formed within the container 20 as shown if FIG. 5B. The dasher 41 can then either tear through the removable barrier 90, as seen in FIG. 5A, or can push the removable barrier 90 from a lateral to a longitudinal orientation, as seen in FIG. 5B. If the dasher 41 is to tear or pierce the removable barrier 90 the sealing band 50 may be left in place. Once the removable barrier is unsealed the cartridge may be shaken to mix the components 140, 150. In another embodiment of the present invention, the sealing band 50 is removed and the cartridge 10 is shaken to unseal the removable barrier.

Still referring to FIG. 4, 5A and 5B, the first chamber 110 may be filled with a first component 140. The second chamber 120 may contain a second component 150 of a two-part coating composition.

For purposes of explanation with respect to a two-component system, the first component can be a liquid, e.g., a solution, and can include one or more materials having at least two reactive groups capable of reacting with the functional groups of the second component. For example, the first component can include one or more materials having reactive groups, such as hydroxyl, epoxy, acid, amine, aziridine, or acetoacetate groups, just to name a few. In one embodiment, the first component can include any conventional resinous or polymeric coating material having two or more reactive groups. For example, the first component can include polyol, polyester, polyurethane, polysiloxane, or polyacrylate-containing materials, just to name a few. In one embodiment, the first component can include a medium molecular weight polymeric polyol, e.g., a polymeric polyol having a number average molecular weight (Mn) in the range of 200 to 100,000.

The second component can be a liquid, e.g., a solution, and can include one or more materials having functional groups configured to react with the reactive groups of the one or more materials in the first component to set or cure (e.g., crosslink with) the materials in the first component to form the resultant coating. For example, but not to be considered as limiting, the second component can include a polyisocyanate curing agent, aminoplast resins, or phenoplast resins, just to name a few. Examples of suitable coating components and curing agents for the practice of the invention are disclosed in, but are not limited to, U.S. Pat. Nos. 6,297,311; 6,136,928; 5,869,566; 6,054,535; 6,228,971; 6,130,286; 6,169,150; and 6,005,045, each of which is herein incorporated by reference in its entirety.

The first component and the second component may comprise one or more materials having functional groups. In certain embodiments of the present invention, the physical characteristics of at least one of the first coating component and the at least one second coating component, is selected by including in such components two or more materials comprising different functional groups. In such embodiments, at least one of the first coating component and the second coating component comprises a first material comprising functional groups of a first chemical species and a second material comprising functional groups of a second chemical species, wherein the first and second chemical species are (i) different one from the other and (ii) compatible with each other. As used herein, the term “compatible with each other” means that the chemical species are storage-stable when combined each other, such that the species do not react so that they component becomes too viscous to be applied.

For example, as mentioned earlier, in certain embodiments the first component can include one or more materials having functional groups selected from the hydroxyl, epoxy, amine, or aziridine chemical species. In such cases where the first component comprises a first material comprising hydroxyl functional groups, the physical characteristics of the first component can be selected by including in that component at least one other material having functional groups of the epoxy, amine, acetoacetate, carbodiimide, aziridine, acrylate, or ketimine, aldimine or aspartic ester chemical species, including mixtures thereof. In cases where the first component comprises a first material comprising epoxy functional groups, the physical characteristics of the first component can be selected by including in that component at least one other material having functional groups of the acetoacetate or alkoxysilane chemical species, including mixtures thereof. In cases where the first component comprises a first material comprising amine functional groups, the physical characteristics of the first component can be selected by including in that component at least one other material having functional groups of the silane chemical species. In cases where the first component comprises a first material comprising aziridine functional groups, the physical characteristics of the first component can be selected by including in that component at least one material comprising functional groups of the alkoxysilane chemical species.

Moreover, as mentioned earlier, in certain embodiments the second component can include one or more materials having functional groups configured to react with the reactive groups of the one or more materials in the first component to set or cure the materials in the first component. In such embodiments, the physical characteristics of the second coating component can be selected by including in such a component two or more materials comprising different functional groups, as indicated above.

For example, in such cases where the second component comprises a first material comprising isocyanate functional groups, the physical characteristics of the second component can be selected by including in that component at least one other material having functional groups of the epoxy, alkoxy silane, or polyanhydride chemical species, including mixtures thereof. In such cases where the second component comprises a first material comprising acrylate functional groups, the physical characteristics of the second component can be selected by including in that component at least one other material having functional groups of the alkoxy silane chemical species. In such cases where the second component comprises a first material comprising acetoacetate functional groups, the physical characteristics of the second component can be selected by including in that component at least one other material having functional groups of the acrylate chemical species. In such cases where the second component comprises a first material comprising anhydride functional groups, the physical characteristics of the second component can be selected by including in that component at least one other material having functional groups of the epoxy or alkoxy silane chemical species, including mixtures thereof.

In certain embodiments of the present invention, the physical characteristics of at least one of the first coating component and the at least one other coating component is selected by including in such components three materials comprising different functional groups. In such embodiments, at least one of the first coating component and the second coating component comprises a first material comprising functional groups of a first chemical species, a second material comprising functional groups of a second chemical species, and a third material comprising functional groups of a third chemical species, wherein the first, second and third chemical species are (i) different one from the other and (ii) compatible with each other.

For example, in certain embodiments, the first component may comprise materials comprising hydroxyl functional groups, materials comprising amine functional groups and materials comprising aspartic ester functional groups. In other embodiments, the first component may comprise materials comprising hydroxyl functional groups, materials comprising amine functional groups and materials comprising alkoxy silane functional groups. Moreover, in certain embodiments, the second component may comprise materials comprising isocyanate functional groups, materials comprising epoxy functional groups, and materials comprising silane functional groups. In other embodiments, the second component may comprise materials comprising isocyanate functional groups, materials comprising anhydride functional groups, and materials comprising acrylate functional groups.

According to one embodiment of the present invention each component of the two-part coating system, the first component 140 and the second component 150, will have a low viscosity. In another embodiment the viscosities of the first component 140 and the second component 150 are substantially equal. The first chamber 110 and the second chamber 120 may contain either the first component 140 or the second component 150 portions of the coating. When the removable barrier 90 is unsealed the first component 140 and second component 150 are mixed to create a single chamber 130 containing a curable coating composition 160 as seen in FIGS. 5A, 5B. With the cartridge 10 inverted and the threads of the dispensing end 30 exposed the cartridge is ready to be inserted into a spray gun 70. It should also be noted that the first component 140 and second component 150 may include additional components such as a tint(s), modifiers, solvent(s) and/or other additives. The additional components may be used to provide color or adjust the rheology of the composition.

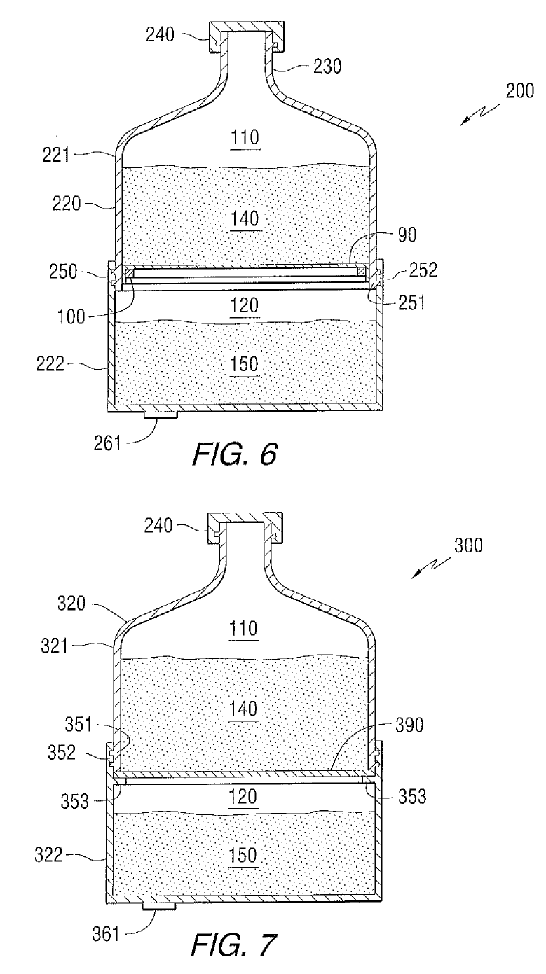

Referring now to FIG. 6, a cartridge 200 is illustrated according to one embodiment of the present invention. In this embodiment, the cartridge 200 has a container 220 with a cap 240 at a dispensing end 230. Note the dispensing end 230 in this embodiment is structured to serve as the male end of a quick disconnect coupling and is fitted with a cap 240. Again, the cartridge 200 has a removable barrier 90 overlapping a rigid member 100. The removable barrier 90 serves to separate first chamber 110 from second chamber 120. The container 220 of the cartridge 200 includes a first section 221 and a second section 222. A compression fitting 250 about the exterior wall of the container 20 joins the two sections. The removable barrier 90 and rigid member 100 are aligned with the threaded inner ring 252 of the compression fitting 250. A female threaded outer ring 252 on the second section 222 is structure to compress a male threaded inner ring 252 on the first section 221. The threads of each are inclined in such a manner that as the compression fitting 250 is tightened, pressure is exerted on the inner ring 252. Accordingly, as the compression fitting 250 is tightened, pressure by the inner ring is exerted on the rigid member 100 so that removable barrier 90 is held securely in place. It should also be understood that the container 220 of this embodiment could also be one piece with external threads. The compression fitting could then comprise an external nut to mate with the external threads. Arranged in a manner similar to the compression fitting described above, the nut would compress the external threads, which would exert pressure on the rigid member 100 so that removable barrier 90 is held securely in place.

Referring now to the embodiment shown in FIG. 7, a cartridge 300 is shown according to one embodiment of the present invention. The cartridge 300 is similar to the embodiment shown in FIG. 6 except the removable barrier 390 is secured with the container 320 in a different manner. A first section 321 of the container 320 has a male threaded inner ring 351. A second section 322 of the container 320 has a female threaded outer ring 352. The second section also has a radially inward annular projection 353. The removable barrier 390 is positioned between the annular projection 352 and a distal portion of the inner ring 351. As the first section 321 and the second section are tightened, the removable barrier 390 is sealed between the inner ring 351 and the annular projection 353. To unseal the removable barrier in the embodiments shown in FIGS. 6 and 7 the container may be unthreaded slightly to free the seal and then retightened. Alternatively, the cap 240 may be removed to allow a dasher-like instrument to be inserted into the container to pierce and/or tear the removable barrier 90,390.

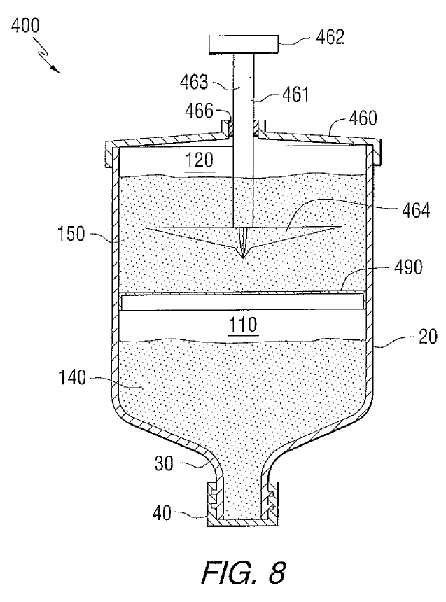

Another embodiment of the present invention is shown in FIG. 8. A cartridge 400 has a container 20 as described above. However, in this embodiment the removable barrier 490 is permanently fixed to the wall of container 20 by way of adhesive or other means. A lid 460 is mounted on the container 20. The lid 460 is equipped with a plunger 461 having a handle 462, shaft 463 and piercing member 464. In this embodiment the removable barrier 490 is made from a thin foil material. The piercing members 464 may be sharply angled metal or plastic pieces so that the plunger 461 may be depressed to tear through the removable barrier 490. This action will expose first chamber 110 to second chamber 120 and allow the first component 140 to mix with the second component 150. A seal 466 is located between the lid 460 and the shaft 463 of the plunger 461.

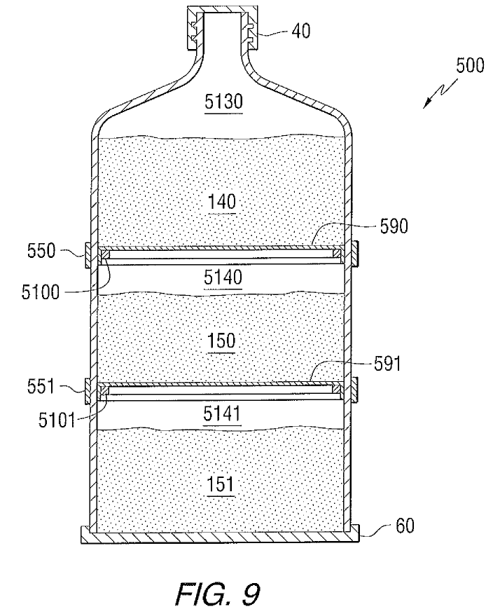

Referring now to FIG. 9, a cartridge 500 is illustrated having three chambers 5130, 5140, 5141 separated by first and second removable barriers 590, 591. Each removable barrier 590, 591 may have a corresponding rigid member 5100, 5101 held in place by corresponding sealing bands 550, 551. The second removable barrier 591 allows a third component 151 to be to be stored in the cartridge 500 separated from the first component 140 or the second component. Attention is drawn to the fact that any number of removable barriers may be used to form any number of chambers. It is also to be noted that the position of any removable barrier and any of the aforementioned embodiments is infinitely adjustable so that the volume of one chamber may be decreased while a second chamber's volume is increased. This repositioning allows for easy adjustment of first component to second component ratios. It should also be apparent that earlier described means for sealing the removable barriers in the cartridge 500 may be employed in this embodiment.

Often the first or second component of coating component contains an epoxy portion and is referred to as the resin. Similarly, the other component will often contain an amine and is referred to as the hardener. With this designation in mind, suitable examples of resin component to hardener component ratios are 1:1, 2:1, 3:1 and 4:1.

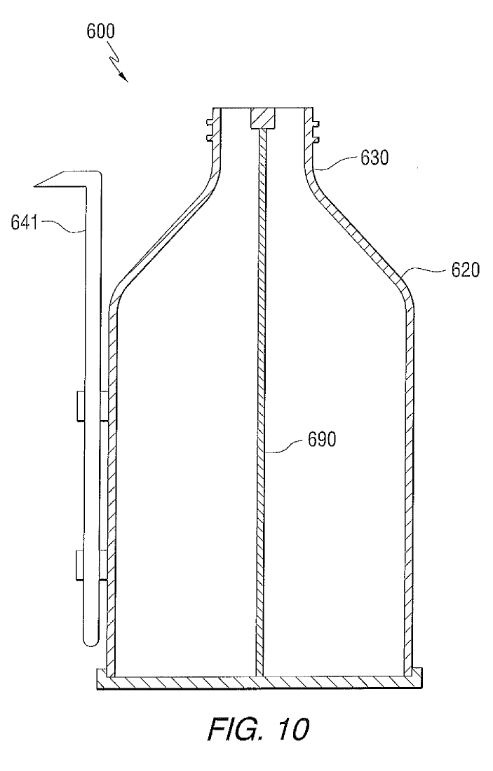

Another embodiment of the present invention is shown in FIG. 10. In this embodiment the cartridge 600 has a longitudinally oriented removable barrier 690. A dasher 641 is removably attached to the side of the container 620. In this embodiment, the dasher 641 is small enough to fit inside the dispensing end 630 of the container 620 and is hooked at one end to tear the foil of the removable barrier 690. In FIG. 10 the cap (not shown) has been removed and dasher 641 can be inserted through dispensing end 630. It should be evident that a removable dasher, like that shown in FIG. 10 but with a different end style, may be utilized in place of the dasher shown in other embodiments.

Whereas particular embodiments of this invention have been described above for purposes of illustration, it will be evident to those skilled in the art that numerous variations of the details of the present invention may be made without departing from the invention as defined in the appended claims.

1. A kit for a coating comprising:
a container with a first chamber and a second chamber;
a removable barrier between the first and second chambers;
a first component in the first chamber;
a second component in the second chamber;
a rigid member supporting the removable barrier; and
a sealing band around the container whereby the sealing band compresses the container to hold the removable barrier in place,
wherein at least one of the first component and second component has a low viscosity.

2. The kit for a coating according to claim 1, wherein the first component comprises a material selected from the group consisting of polyols, polyesters, polyurethanes, polysiloxanes, and polyacrylates.

3. The kit for a coating according to claim 1, wherein the second component comprises a material selected from the group consisting of polyisocyanates, aminoplast resins, and phenoplast resins.

4. The kit for a coating according to claim 1, wherein the first component and the second component have low viscosities.

5. The kit for a coating according to claim 1, wherein the first component and the second component have viscosities which are substantially equal.

6. The kit for a coating according to claim 1, wherein the sealing band compresses the container to hold a peripheral section of the removable barrier fixedly between the container and the rigid member.

7. The kit for a coating according to claim 1, wherein the removable barrier is a metallic foil.

8. The kit for a coating according to claim 1, wherein at least one of the first chamber and second chamber is made of plastic.

9. The kit for a coating according to claim 1, wherein the container is disposed of after one use.

10. The kit for a coating according to claim 1, wherein the container comprises a dispensing end structured and arranged to connect to an inlet of a paint spray gun.

11. The kit for a coating according to claim 10, wherein the container is connectable to the inlet of the paint spray gun by a threaded connection.

12. The kit for a coating according to claim 1, further comprising means for piercing the removable barrier.

13. The kit for a coating according to claim 1, wherein the first chamber is threadedly engaged with the second chamber.

14. The kit for a coating according to claim 1, wherein the first chamber has a first opening for receiving the first component and the second chamber has a second opening for receiving the second component.

15. The kit for a coating according to claim 1, further comprising a third chamber.

16. A method of filling a coating cartridge comprising the steps of:
providing a container comprising first and second chambers separated by a removable barrier;
filling the first chamber with a first coating component; and
filling the second chamber with a second component.

17. The method of filling a coating cartridge of claim 16, wherein the first component enters the first chamber through a first opening and the second component enters the second chamber through a second opening.

18. The method of filling a coating cartridge of claim 16, further comprising the step of installing a removable barrier after filling the first chamber with the first component and before filling the second chamber with the second component.

19. The method of filling a coating cartridge of claim 16, further comprising the step of connecting the second chamber and removable barrier to the first chamber after filling the first chamber with the first component and before filling the second chamber with the second component.

20. The method of filling a coating cartridge of claim 16, further comprising filling a third chamber with a third component.

21. An assembly for spray painting comprising a spray gun and a cartridge in fluid communication with the spray gun, wherein the cartridge comprises:
a first chamber for a first paint component;
a second chamber for a second paint component; and
a removable barrier between the first and second chambers which is removed to allow the first and second paint components to mix.

22. The apparatus for spray painting of claim 21, wherein the cartridge is disposed of after one use.

23. A method of spray painting comprising:
providing a paint cartridge having a first chamber containing a first coating component, a second chamber having a second coating component and a barrier separating the first and second chambers;
removing the barrier to mix the coating components in the cartridge;
mounting the cartridge on a spray gun; and
spraying the mixed coating components from the spray gun.
